(19) United States
(12) Patent Application Publication
(10) Pub. No.: US 2004/0109428 A1
(43) Pub. Date: Jun. 10, 2004

(54) Method and apparatus for resource allocation for multiple traffic classes in wireless ad-hoc networks

(76) Inventor: Srikanth Krishnamurthy, Riverside, CA (US)

Correspondence Address: TOPE-MCKAY & ASSOCIATES, 23852 PACIFIC COAST HIGHWAY #311, MALIBU, CA, 90265, US

(21) Appl. No.: 10/315,913

(22) Filed: Dec. 9, 2002

(51) Int. Cl. H04Q 7/24

(52) U.S. Cl. 370/338; 370/436

(57) ABSTRACT

The present invention provides a resource manager that is configured to support bandwidth re-use across the network. Further, the resource manager provides that when two nodes are distant from each other, the transmission of a first node does not cause significant co-channel interference that often hampers the transmissions of the second node. The resource manager further allows the two nodes to re-use the same bandwidth. The resource manager attempts to dynamically manage bandwidth allocations such that frequency re-use is supported and maximized.

### BACKGROUND

(1) Technical Field

The present invention is generally related to wireless ad-hoc networks, and more particularly to a technique for resource allocation in wireless multi-hop ad-hoc networks.

(2) Discussion

Work to-date on medium access control protocols for wireless multi-hop ad-hoc networks has failed to adequately address the issues of guaranteed bandwidth and other quality of service (QoS) issues. In conventional wireless ad-hoc networks, bandwidth reservation is restricted to a single link by use of Request-to-Send/Clear-to-Send (RTS/CTS) signaling. This signaling is more completely described in the IEEE 802.11 standard. These bandwidth reservation schemes are not suitable for supporting real time multimedia services because they introduce a delay jitter. The delay jitter experienced by packets is generally unacceptable for real-time applications. A simple way to overcome delay jitters using these existing systems is to reserve bandwidth for each individual call such the bandwidth is not re-usable within the network. While effective, this method results in a significant waste of bandwidth.

Therefore there is a need for a resource manager that would be configured to support bandwidth re-use across the network. Accordingly, it would be desirable to provide a system whereby two distant nodes would be able to communicate without causing significant co-channel interference. Such interference can hamper the transmissions of the other nodes in the network.

### SUMMARY

The present invention provides a resource manager that is configured to support bandwidth re-use across a network. Further, when a first node and a second node are widely separated, the resource manager prevents co-channel interference resulting from the transmission of the first node. Wherein such co-channel interference can hamper the transmission of the second node. The resource manager further allows the two nodes to re-use the same bandwidth. The resource manager attempts to dynamically manage bandwidth allocations such that frequency re-use is supported and maximized.

In one aspect of the present invention, the methodology for resource allocation provides a call from a source node and determines if the node was involved in an earlier call setup, if the call was previously involved in call setup, the call is dropped and the protocol is terminated. Otherwise a call setup packet is transmitted to a time stamped relay node. The source node waits for either an abort packet, in which case the call is dropped or a timeout signal where the call is dropped and a drop call packet is sent.

If the required resources are available the connection is deemed successful. In such a situation the required resources are allocated, and the packet is sent on the assigned slot. In the situation where the relay node is already involved in a call setup, the methodology according to the present invention determines which call setup originated first. This may be accomplished with the aid of a timestamp created when the call set-up originated. Based on the timestamp a decision is made which call setup will prevail.

Specifically, the present invention operates in four phases: initializing a call, setting up the call, maintaining the call, and terminating the call. Each of these phases may be performed as a method, by an apparatus, or may be stored on a computer-readable medium as a computer program product.

The process of initializing a call begins by determining whether the source node is involved in an earlier call setup, and if the source node is involved in an earlier call setup, dropping the call. When the source node is not involved in an earlier call setup, it pings along a path from the source node to the destination node in order to to determine whether the path can be used for call setup. When the path cannot be used for call setup, the call is dropped.

On the other hand, when the path can be used for a call setup, the source node transmits a call setup packet along the path and awaits a reaction relay setup message until a timeout is reached. If the timeout is reached before the reaction relay setup message is received, the node transmits a drop call packet and drops the call. However, when a relay setup message is received before the timeout is reached; the node analyzes the relay setup message to determine whether the setup was a success. If the setup was unsuccessful, the node transmits a drop call packet and drops the call. If, on the other hand, the setup was successful, the node allocates resources to the call and transmits call data.

The process of setting up a call between the source node and the destination node via relay nodes is performed by receiving a call setup packet from a source node at a relay or destination node. Next, the receiving node determines whether it is involved in an earlier call setup. When the relay or destination node is already involved in an earlier call setup, it determines whether a call involved in the earlier call setup has a higher priority than the call involved in the current call setup. If the current call setup has a higher priority, the node sends a negative relay setup message for all other calls so they are terminated. On the other hand, if the current call setup does not have a higher priority, the node sends a negative relay setup message to the source node, aborting the current call setup.

When the relay or destination node is not already involved in an earlier call setup or when the relay or destination node is involved in an earlier call setup, but the current call setup has a higher priority, the node determines whether the relay or destination node is a relay node or a destination node. If the relay or destination node is a destination node, the node finds an appropriate slot vector and sends a call setup response toward the source. On the other hand, if the relay or destination node is a relay node, it forwards a call setup packet toward a further destination node, finds an appropriate slot vector, awaits and collecting relay node information from nodes toward the further destination node, and sends a call setup response toward the source.

After the call setup response has been sent toward the source, the node determines whether the call setup was a success. When the call setup was not a success, the node sends a negative relay setup message to the source node, aborting the current call setup. On the other hand, when the call setup was a success, the node removes a call pendency and sets a slot vector, sends a relay setup message back toward a source node, and awaits a data transaction.

After a call setup is complete the network of nodes maintains a call at each node by first waiting for a next packet. When the next packet is not received prior to a predetermined time period, the node releases call resources and assumes the call terminated. On the other hand, when the next packet is received prior to a timeout, the node snoops for transmissions of a next node along the route to the destination node for a predetermined time period and determines whether the next node has further retransmitted a previous message.

When the next node has retransmitted the previous message within the predetermined time period, the node retransmits the next packet to the next node and waits for the next packet. On the other hand, when the next node has not retransmitted the previous message within the predetermined time period, the node transmits a message back toward the source node to setup a new transmission path and releases call resources.

Once the call has been completed, the call is terminated. In this operation, a call message is transmitted from the source node toward the destination node via any relay nodes along the path from the source node to the destination node. At each relay node along the path, the call termination message is received and retransmitted, call resources are released, and a slot vector is modified appropriately. At the destination node, the call termination message is received, call resources are released, a slot vector is modified appropriately, and a destination handshake is transmitted back along the path toward the source node. At each relay node along the path, the destination handshake is forwarded toward the source node. Finally, at the source node, the handshake is received and call resources are released.

### BRIEF DESCRIPTION OF THE DRAWINGS

The present invention will be better understood with reference to the following detailed description with reference to the appended drawings, in which:

FIG. 1 is a block diagram of a computer system used in conjunction with the present invention;

FIG. 2 is an example of a computer program product aspect of the present invention, in the form of a computer-readable medium;

FIG. 3 is an illustration of how resources are allocated for constant bit-rate calls;

FIG. 4 is an illustration of how resources are allocated when race conditions exist during the call setup phase;

FIG. 5 is a flowchart depicting the call setup process at the source;

FIG. 6 is a flowchart depicting the call setup process at the relay node and the destination;

FIG. 7 is a flowchart depicting a call in progress between relay nodes;

FIG. 8 is a flowchart depicting the message termination process; and

FIG. 9 is a graphical representation showing a typical negotiation during a variable bit-rate connection.

### DETAILED DESCRIPTION

The present invention is generally related to wireless ad-hoc networks, and more particularly to a technique for resource allocation in wireless multi-hop ad-hoc networks. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader. Next, a discussion of various physical aspects of the present invention is provided. Finally, a discussion is provided to give an understanding of the specific details.

### (1) Glossary

Before describing the specific details of the present invention, a centralized location is provided in which various terms used herein and in the claims are defined. The glossary provided is intended to provide the reader with a feel for the intended meaning of the terms, but is not intended to convey the entire scope of each term. Rather, the glossary is intended to supplement the rest of the specification in more accurately explaining the terms used.

Means—The modules and operations herein are generally computer operations. Non-limiting examples of “means” include computer program code (source or object code) and “hard-coded” electronics (i.e. computer operations coded into a computer chip). The “means” may be stored in the memory of a computer or on a computer readable medium. The term means may also be used to provide general functional language for other hardware components of the invention.

(1) Principle Aspects

The present invention has three principal hardware aspects. The first is a system for allocating resources in wireless multi-hop ad-hoc networks, and is typically in the form of a computer system, computer component, or computer network operating software or in the form of a “hard-coded” instruction set. This system may take a variety of forms with a variety of hardware devices, and may include computer networks, handheld computing devices, cellular networks, satellite networks, and other communication devices. The second physical aspect is a method, typically in the form of software or hardware, operated using a data processing system (computer or computer network). The third principal physical aspect is a computer program product. The computer program product is generally in the form of computer readable code stored on a computer readable medium such as an optical storage device, e.g., a compact disc (CD) or digital versatile disc (DVD), or a magnetic storage device such as a floppy disk or magnetic tape. Other, non-limiting examples of computer readable media include hard disks, read only memory (ROM), and flash-type memories. These aspects will be described in more detail below.

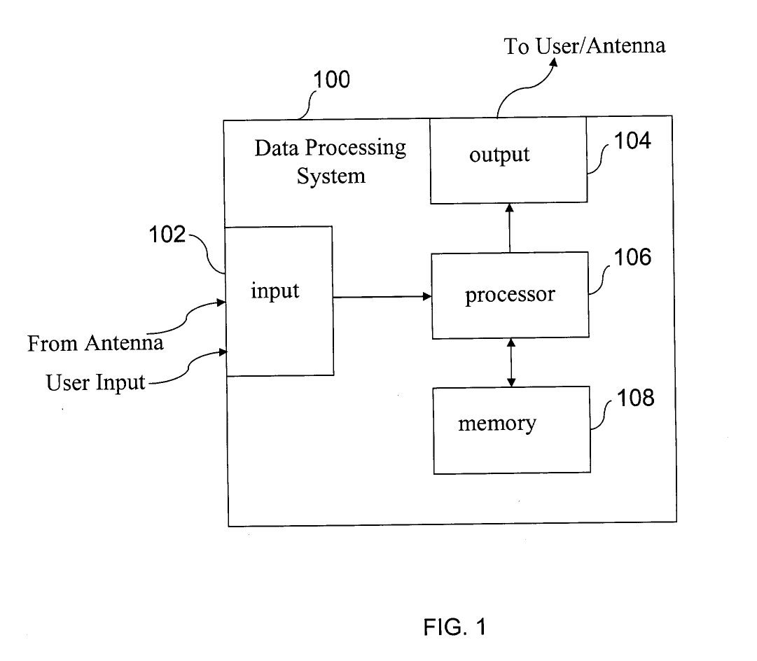

A block diagram depicting the components of an example computer system used in the present invention is provided in FIG. 1. The data processing system 100 comprises an input 102 for receiving information in the form of user input as well as input from other devices, databases, and/or programs. Note that the input 102 may include multiple “ports.” The computer system serves as a node, which generally communicates with other nodes in a network via a wireless communication connection. An output 104 is connected with the processor for communicating with other devices as well as for providing output to a user. Output may also be provided to other programs, e.g. to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software to be manipulated by commands to the processor. A plurality of data processing systems 100, along with other devices, forms a communication network in which the present invention may operate.

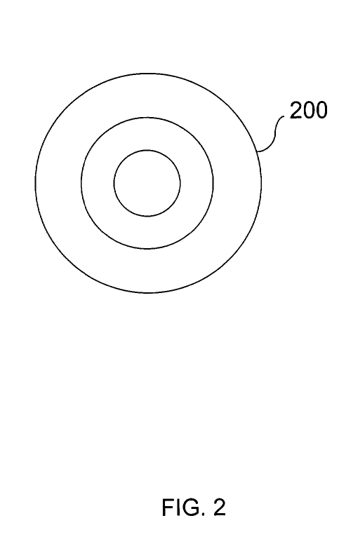

An illustrative diagram of a computer program product embodying the present invention is depicted in FIG. 2. The computer program product 200 is depicted as an optical disk such as a CD or DVD. However, as mentioned previously, the computer program product generally represents computer readable code stored on any compatible computer readable medium.

### (3) Discussion

One aspect of the present invention provides a resource manager that is configured to support bandwidth re-use across the network. Further, the resource manager provides that when two nodes are distant from each other, the transmission of a first node does not cause significant co-channel interference, which often hampers the transmissions of the second node. The resource manager also allows the two nodes to re-use the same bandwidth. The resource manager attempts to dynamically manage bandwidth allocations such that frequency re-use is supported and maximized.

The resource manager functions to provide a coarse level of quality of service in terms of bandwidth to real-time continuous bit-rate and variable bit-rate connections in a wireless ad-hoc network. The resource manager has to reserve resources along a route from the source node to the destination node. This reservation is required for each call and is the means by which quality of service may be guaranteed. Each constant bit-rate call requires a fixed amount of bandwidth periodically, i.e., a fixed number of slots every frame. The resource manager first attempts to reserve the necessary resources on the route indicated by the routing layer. If resources are inadequate and a path is not found, that information is relayed back to the routing layer. The routing layer then attempts to find an alternate route where the required resources are available. If no route can be found, an admission controller will reject the call.

For a variable bit-rate call, the resource manager attempts to reserve some fixed bandwidth on the route from the source to the destination. The reserved bandwidth might be equal to the average bandwidth requirement of the variable bit-rate call. The call set-up phase is substantially identical to the call set-up phase for a constant bit-rate call. Once the call is set up, a variable bit-rate call would negotiate for additional bandwidth requirements, as needed, on a frame-by-frame basis. If the number of slots required to carry a particular variable bit-rate burst is less than the number of allocated slots, the excess slots may be relinquished for use by other variable bit-rate calls. At the same time, a user or node may decide to piggyback queued datagram packets on a variable bit-rate call, provided sufficient bandwidth is available.

The resource manager of the present invention is a novel concept in the area of wireless ad-hoc networks. The resource manager attempts to provide quality of service guarantees in terms of bandwidth in an ad-hoc network at the link level. While, the mobility of the nodes and the harshness of the environment make it impossible to provide deterministic quality of service guarantees, the resource manager will provide a coarse level of quality of service. The messages exchanged for call set-up and call tear-down are simplistic and have low overhead. This is in contrast to traditional bandwidth reservation protocols that function at the networking (IP) layer such as RSVP. The solution of the present invention is especially desirable because wireless ad-hoc networks support relatively low bandwidths and generally cannot sustain high overheads. Once bandwidth is reserved on a particular route for a given call, that call will enjoy sustained bandwidth until and unless a node en route fails or moves out of range. Thus, for pedestrian environments such as special weapons and tactics police work, search and rescue operations, firefighting, and infantry deployment, the short duration (of the order of minutes) real-time calls are ideally supported. Typical applications that might benefit from such a resource reservation methodology include those such as very important real time calls consisting of both audio and video.

The resource manager has been developed for a time division multiple access (TDMA) based architecture but can readily be modified to function on top of any other medium access control (MAC) infrastructure. This invention will find application in virtually any present or future wireless ad-hoc network, which will carry real-time traffic, User Datagram Protocol (UDP) traffic, or traffic requiring some form of Quality of Service (QoS). The resource manager, as indicated above, attempts to reserve resources on a particular path or route from a source node to a destination node, to facilitate dedication of bandwidth to a particular call. The call could then enjoy quality of service guarantees in terms of dedicated bandwidth as long as the nodes along the route do not fail or move away. When a node fails, or moves, the resource manager attempts to reserve resources along an alternate path or route. An admission controller is utilized to minimize the probability of dropping a call due to such a node failure or movement.

Herein, a plurality of representative examples is presented to illustrate the functionality of the resource manager. For simplicity, it will initially be assumed that only constant bit-rate services are supported. The QoS metric for this traffic class would be a dedicated fixed-bandwidth node with an absolute delay bound. The resource manager is configured to reserve bandwidth on the route from a source node to a destination node. The reserved bandwidth is used to support the constant bit-rate call. Once reserved, this dedicated bandwidth can no longer be used for any other data traffic. The resource manager maintains a vector to depict the slots in the TDMA frame. If the k^{th} element of the vector is 0, then the k^{th} slot of the TDMA frame is free, and may be utilized by a new constant bit-rate call. Conversely, if the k^{th} element of the vector is non-zero then the particular slot may not be used by a new constant bit-rate call.

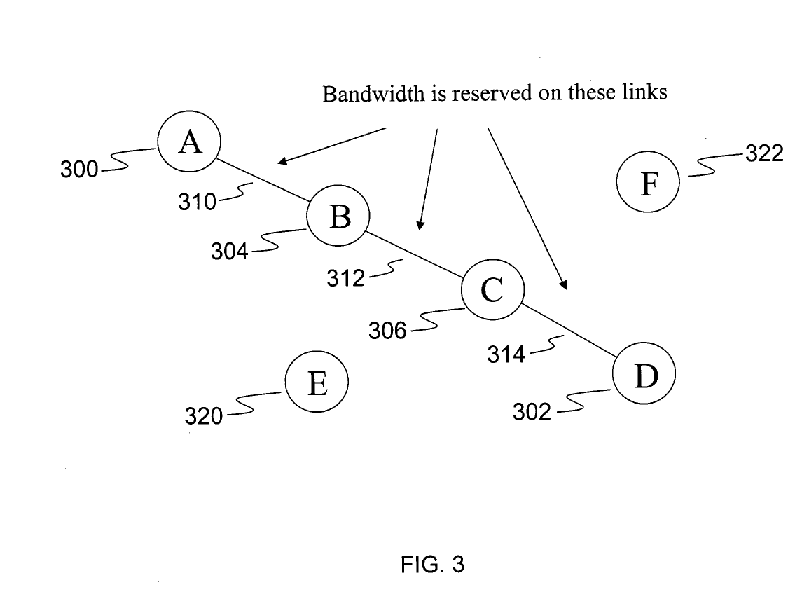

To illustrate the functionality of the resource manager under the conditions described above, the following example is presented. It is assumed that there are ten slots in every frame, and that each slot may be used for constant bit-rate services. The resource manager of each node maintains a slot vector, which in this case consists of ten elements. The vector is first initialized to an all-zero state. If a particular position in the slot vector is set to non-zero, it means that the node can no longer use that slot of a frame for transmission or reception. For example, if the resource manager of a node has a vector value of ‘1100002200’, the node can no longer accommodate a new call on slots 1, 2, 7, or 8. However, new calls can reserve the other slots. The resource allocation scheme for a constant bit-rate call is set forth in FIG. 3, wherein the originating node is node A 300 and the destination node is node D 302. The relay nodes are B 304 and C 306. The resource manager reserves the required bandwidth on the links between A and B 310, B and C 312, and C and D 314. Nodes E 320 and F 322 are other nodes in the wireless ad-hoc network.

Let the vectors of nodes A 300, B 304, C 306, and D 302 be 1111100000, 2220000000, 1100000012, and 0000000001 respectively. When node A 300 wants to set up a constant bit-rate call requiring 2 slots at every frame from node A 300 to node D 302, the node looks to the routing layer to find a route for the call. The routing layer makes an initial determination concerning the route for the call. Here, the routing layer determines that the call from node A 300 is to be routed through nodes B 304 and C 306. The routing layer then transmits its vector and additional information such that node B 304 recognizes that there is a new call that is to routed to node D 302 via node C 306. Node B 304 compares the vector sent by node A 300 with its own vector and performs an element-by-element addition operation. It then transmits this modified vector in this case 3331100000 with the additional information about the required bandwidth etc. Node C 306 receives this message and performs an element-by-element addition of its own vector to this modified vector to get a new value of 4431100012. Nodes E 320 and F 322 may also receive these messages due to the broadcast nature of the wireless channel, but they remain passive for the time being. Node C 306 will then broadcast its own message with this new vector to be received by node D 302. Upon receipt, node D 302 performs an element-by-element addition of the received vector with its own vector and it determines that slots 6, 7, and 8 may be used for setting up this new connection. The node arbitrarily selects slots 6 and 7 and transmits a call set-up message to Node C 306, which relays the message to Node A 300 via Node B 304. The call is then established and slots 6 and 7 are reserved for this call. Nodes A 300, B 304, C 306, and D 302 change their vectors to reflect that slots 6 and 7 are reserved. This is accomplished by changing the elements at the corresponding positions to 1. It is also to be noted that nodes E 320 and F 322 which detect the exchange of the messages at route set-up, can also no longer use slots 6 and 7 for communication since doing so would lead to collisions. Thus, node E 320 and node F 322 would also change their vectors to reflect that slots 6 and 7 are reserved and cannot be used for setting up a new connection. It is worth noting that these slots would have to be unused during the initial call setup. If they were in use, the use would necessarily have been reflected in the vectors of either node B 304 or node C 306, which detect node E 320 and node F 322. When the call terminates, the resource manager sends control messages to free the corresponding bandwidth.

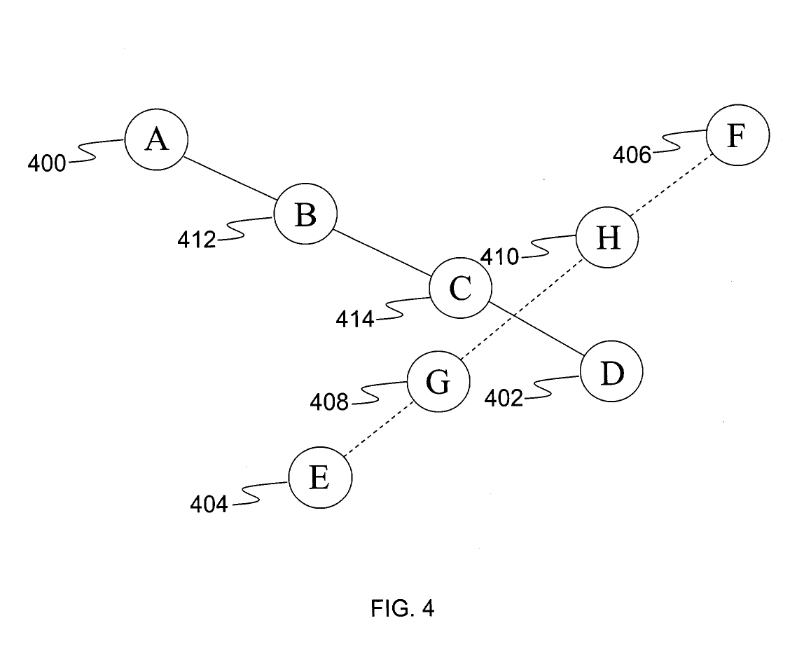

Simultaneous attempts to set up calls between nearby nodes could lead to race conditions. To illustrate this effect, consider the following example set forth graphically in FIG. 4, wherein node A 400 attempts to set up a call with node D 402. Simultaneously, node E 404 attempts to set up a call to node F 406. According to the methodology described in the previous subsection relative to FIG. 3, during call set-up phase vectors are passed between the nodes on the route from the source, node A 400, to the destination, node D 402, in order to reserve resources along that route. However, the nearby nodes E 404 and F 406 mark their vectors to indicate a “reserved” status for unusable slots only after the destination node transmits a message to indicate a successful call set-up.

In the above example, if there was no attempt to set up a call from node E 404 to node F 406, at the end of the call set-up phase for the call from node A 400 to node D 402, nodes G 408 and H 410 would change their vectors to reflect that the TDMA slots being used for the call from node A 400 to node D 402 can no longer be used for any calls being routed through them. However, if there is an attempt to set up a call from node E 404 to node F 406 at the same time, the same resources may be reserved for both this call and the call from node A 400 to node D 402, i.e., a race condition occurs. This may be recognized when the ‘end of call set-up’ message is transmitted, i.e., certain nodes would recognize that their vectors have changed since they transmitted their call set-up messages and will have to re-attempt to set up the call in question. This situation can also be avoided by not permitting simultaneous call set-up attempts among nodes, which can detect each other. Each node may turn a flag on or off depending on whether the node can be involved in a call set-up attempt.

One way of dealing with race conditions is to incorporate an arbitration methodology such as time stamping. During time stamping priority is given to a call set-up message that has existed for the longest time in the network. If a node receives a new call set-up message when it is involved in a previous call set-up, it first looks at the timestamps of the two call set-up messages. It then sends an abort message to the source (and destination if required) of the call set-up message with the later time stamp.

The resource manager requires a deterministic route from the upper routing layers in order to reserve resources. In the absence of a valid route, the resource manager would fail to reserve resources. In a highly mobile environment, node topology varies and routes may change in real time. Under such circumstances, bandwidth reserved on old routes will have to be released for use by other calls and bandwidth will have to be reserved on new routes. Similarly, in the harsh wireless environment, packets might be lost due to fading. The resource manager will have to ensure that the system does not crash or go chaotic when control messages are lost. Hence, some form of error protection should be provided at the MAC layer in addition to forward error correcting codes (if deployed).

The resource manager will need a route from the source node to the destination node in order to reserve resources. Generally, routing layer mechanisms to provide this route. If no route is available, the resource manager might try to find a route by using a ping or route discovery message to the destination. If no route is reported before a predetermined time-out, the call set-up is aborted. If a route is reported, a call set-up message is transmitted in order to reserve resources. The source node then waits for an acknowledgement from the destination node. If no acknowledgement is received before a predetermined time-out, the call is aborted; multiple attempts might be made to set up a call. Conversely, if a successful acknowledgement is received, the source starts streaming packets in the assigned slots.

A relay node expects to receive packets periodically from the previous relay node along the route. For example, in order to avoid collisions, a node may transmit only once in any desired number of frames, in the example herein there are desirably three frames. For example, in FIG. 4, node A 400 can transmit only if nodes B 412 and C 414 are not transmitting. If node B 412 is transmitting, it cannot receive packets from node A 400 simultaneously. If a transmission from node C 414 occurs contemporaneously with a transmission from node A 400, a collision at node B 412 will result. Thus, the periodicity with which a relay node expects to receive packets from its predecessor on the route in this case is once in three frames. If a relay node does not receive packets from its predecessor within a predetermined number of frames, the relay node assumes that the route to the destination is no longer valid. This loss of route may be due to reception changes resulting from node mobility or harsh fading. In such a case, the node concludes that the call has been terminated and releases the resources reserved for this particular call.

A relay node also monitors the transmissions of the next immediate successive node along the route. Due to the broadcast nature of the wireless medium, this is readily accomplished. If the earlier relay node does not detect its successor relay node for retransmitting the packets it had been transmitting, then the earlier relay node recognizes that the route is no longer valid. The invalidity may arise as a result of any number of factors; for example, situations where a successor relay node along the route has moved; or where the channel is in a deep fade. In the latter case, the earlier relay node sends a message to the source node indicating this transition. The source node then attempts to reestablish the connection by first searching for a new route and then reserving resources.

If a node moves, it might enter the vicinity of other connections. If two connections cross each other because of node movement, the two connections might start jamming each other. In such a scenario, packets will be lost and relay nodes will inform the source node of this transition and the resulting incompatibility. The source nodes will then try to re-establish connections. At this time the two calls will be allocated different time slots using the arbitration methodology suggested earlier (time stamping). The methodology suggested occasionally may result in dropping one of the two calls. However, the methodology is amenable to modification. One such modification may include allowing multiple attempts before concluding that a call cannot be established. The result of this is that both calls are established if resources are available.

Upon call termination, the source node transmits a call termination message, which is relayed to the destination node. The relay nodes release resources en-route so that the bandwidth may be used by other calls. At this time, adjacent nodes will also set their slot vectors in order to appropriately to reflect this change. A handshake is used to ensure that the termination message is not lost (in the absence of a handshake, resources might never be released, or potentially would have to wait for a timeout). In this case, the destination will acknowledge the receipt of a termination message.

Occasionally, a particular node may flag a slot as unusable because multiple non-interfering connections in the node's vicinity may be using the slot. However, the node is only deemed usable when all such calls terminate. Generally, a call termination is explicit in that the communicating nodes transmit a signal indicating that the call is over and that the slot is again free for use. However, in cases where nodes are mobile, it is possible for the node that flagged the slot as unusable to move outside the vicinity of the interfering connections. As a result, the node would not receive any indication that the slot has become free and would continue assuming that the slot is unusable. In order to ensure that the slot is properly freed, nodes periodically transmit a control message indicating their slot usage. If a node finds that a particular slot is not being used (because it is not flagged) in the slot vectors of all of its adjacent nodes, then the node will change the slot status from unusable to usable.

Call Setup: Source, Relay, and Destination

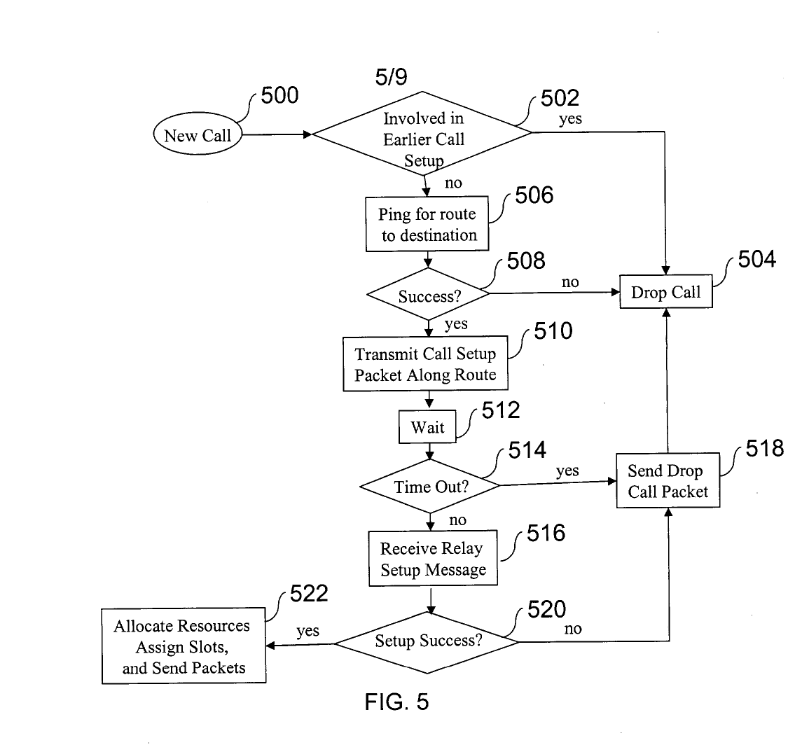

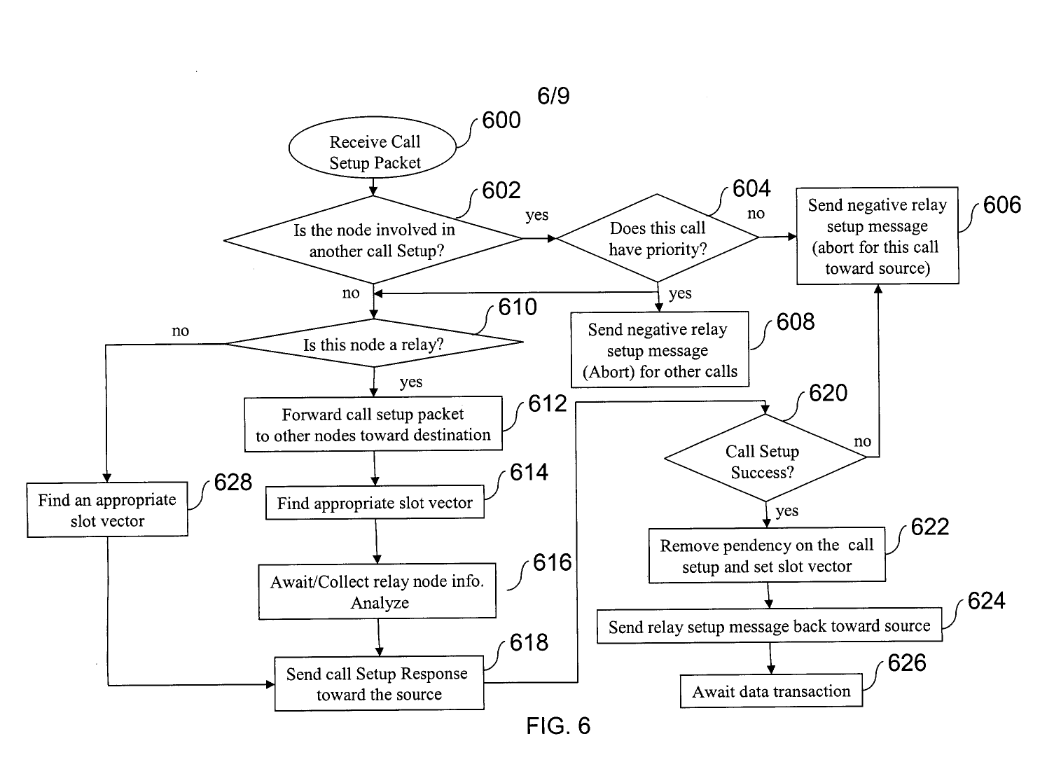

The call setup process is show in FIG. 5 and FIG. 6. FIG. 5 is a flow chart depicting the steps involved in setting up a call from the point of view of the source node (the caller). FIG. 6 is a flow cart depicting the steps involved in setting up a call from the point of view of relay nodes along the path, as well as the destination node (the callee).

Referring now to FIG. 5, a decision is made at a source node to initiate a new call or a handoff call 500. Once the new call or handoff call 500 has been initiated, the node checks to determine whether the node is still involved in the setup of an earlier call 502. If the node is involved in the setup of an earlier call 502, the node drops the new call 504. If the call is dropped 504, the process must start again if the call is still desired. Note that this assumes that only one call setup can take place at a time. It is also possible for multiple calls to take place simultaneously on different frequencies, etc. using different antennas. If the node is not involved in the setup of an earlier call 502, the node pings for a route to the destination node 506. The pinging step 506 is performed to determine whether there is an available route from the source node to the desired destination node. If the pinging is unsuccessful 508, the call is dropped 504, as there is no available route for communication from the source node to the destination node. On the other hand, if the pinging is successful 508, the source node transmits a call setup packet along the route to the destination node 510. Note that the receipt of the call setup packet and its processing at the relay and/or destination nodes will be discussed with regard to FIG. 6.

At this point, the source node waits for a reply from a neighboring relay and/or destination node 512. The waiting 512 is performed until either a specified timeout is reached 514, or until the source node receives a relay setup message 516 from a relay and/or destination node. If a timeout is reached 512, the source node assumes that a call cannot be completed, and sends a packet informing other nodes of its intent to drop the call 518. The source node then drops the call 504. On the other hand, if a timeout is not reached 514, and the source node receives a relay setup message 516, the node then proceeds to analyze the relay setup message to determine whether the call setup was successful 519. If the call setup failed, the source node sends a packet informing other nodes of its intent to drop the call 518, and then drops the call. If the call setup was successful 520, the node allocates its resources, assigns the proper slots, and transmits its data packets 522.

As previously mentioned, FIG. 6 is a flow cart depicting the steps involved in setting up a call from the point of view of relay nodes along the path, as well as the destination node (the callee). After receiving a call setup packet 600, the receiving node checks to determine whether it is involved in another call setup 602. If the node is involved in another call setup, the node determines whether this call has priority over other setups 604. This action is generally performed by comparing the timestamp of the current call with those of other calls, with the call having the earliest timestamp receiving priority. Note that other mechanisms may be used for determining priority. For example, very important calls may be allotted a particular priority to provide greater assurance that they will be completed. If the call in question does not have a higher priority (e.g., an earlier timestamp) than others, then the node will send a negative relay setup message back toward the source node to inform nodes along the path that the call should be considered aborted 606. On the other hand, if the call in question does have a higher priority than other calls, then the node will send a negative relay setup message (e.g., abort packets) for other calls 608 along paths to their source nodes to inform them that the calls should be considered aborted. At approximately the same time, the node determines whether it is a relay node 610. To do this, the node could, for example, check the call setup data to determine if it is the destination node. If it is not, then it is a relay node. Note that if the node is not involved in another call setup 602, then the determination of call priority is unnecessary, and the process proceeds immediately to the determination of whether the node is a relay node 610. If the node is a relay node 610, then the node adds its call vector to the received vector and forwards the call setup packet to other nodes en-route to the destination node 612. The node then finds an appropriate slot vector for the pending transmission 614, and awaits and collects relay node information from nodes in the direction of the destination 616. The node analyzes this information to determine whether the call setup will be successful. The node then sends a call setup response back along the path toward the source 618. If the call setup will not be successful 620, the node sends a negative relay setup message for this call back toward the source node 606, and the call is thus terminated. On the other hand, if the call setup will be successful, the node removes the pendency on the call setup and sets the slot vector 622. The node then sends the positive call relay setup message back toward the source to confirm that the transmission can be successfully commenced 624. The node then awaits a data transmission 626.

On the other hand, if the node is not a relay node 610, it is a destination node. In this case, the node finds an appropriate slot vector 628, as the relay node did at block 614. After finding an appropriate slot vector 628, the node sends a call setup response 618. Continuing from block 618, the destination node behaves like a relay node up to the point of awaiting a data transmission 626.

Call Maintenance: Relay from Node to Node

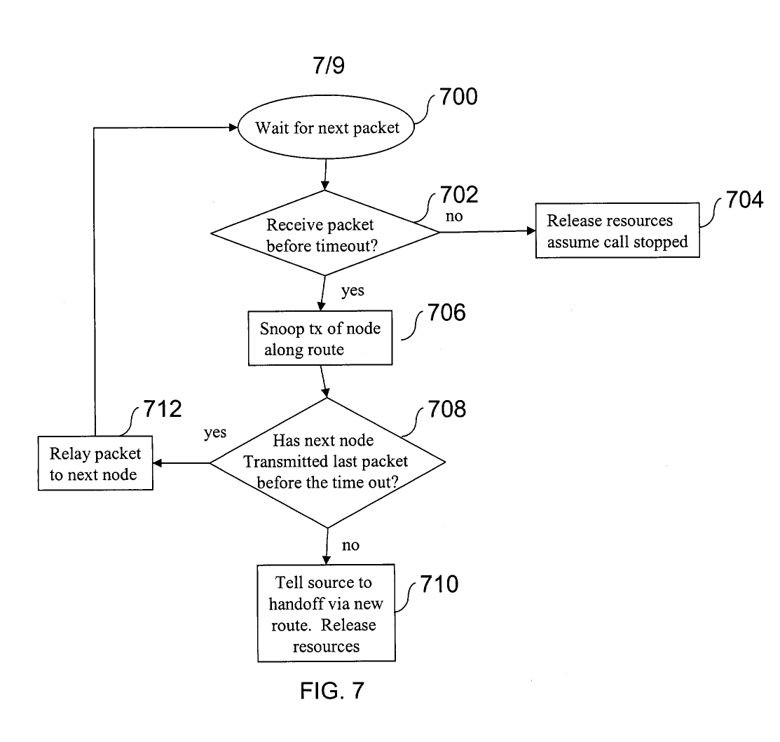

Once a call has been set up, data is relayed from the source node to the destination node via relay nodes. FIG. 7 depicts the process that occurs as data is relayed from node to node. A relay node awaits a next data packet 700. If no packet is received before a timeout is reached 702, the node releases the resources reserved for the call and assumes that the call is stopped 704. On the other hand, if a packet is received before the timeout is reached 702, the node “snoops,” or listens to the transmissions of the next node en-route to the destination node 706. The node is able to do this because the transmissions performed in conjunction with the present invention are generally omni-directional. If the next node has not transmitted the last packed transmitted by the relay node prior to a specified timeout 708, the relay node sends a transmission in the direction of the source node to tell the source node to hand off the transmission by finding another route to the destination node 710. The relay node then releases the resources reserved for the call and assumes that the call is stopped. If, via snooping, the relay node determines that the next node has re-transmitted the call setup packet prior to the timeout 708, the relay node sends the next packet to the next node along the path between the source node and the destination node 712. The node then resumes waiting for the next packet in the call 700. This process continues until either the call is lost or until the call is completed and the node receives a message informing it of the call's completion.

Call Termination: Propagation of the Termination Message

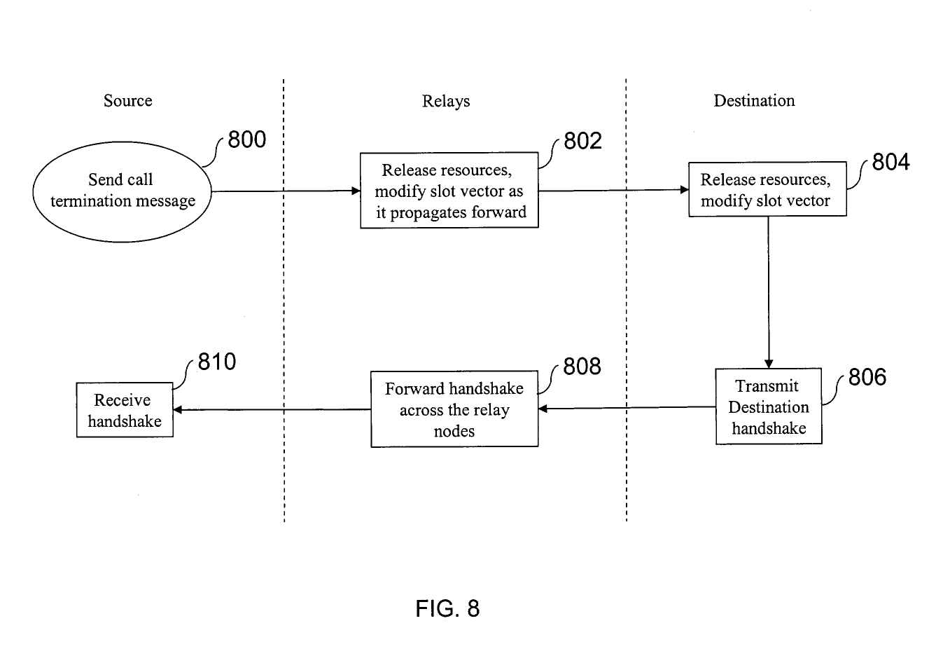

Once a call has been completed, it is desirable for the source node to inform the other nodes in the network that there is no more data to be transmitted in order to free system resources. The call termination process is depicted in FIG. 8. Note that FIG. 8 shows the propagation of a call termination from the source node to the destination node, and the corresponding handshake message from the destination node. Calls may be terminated in other ways, such as, for example, timeouts that are employed during the call setup or maintenance stages. However, calls terminated through these means are typically not complete.

The call termination process begins with the transmission of a call termination message from the source node 800. The call termination message is propagated through the relay nodes, informing them to release resources dedicated to the call, and to modify their slot vectors as it is propagated forwarded through the network 802. After the call termination message has been propagated through the network 802 and arrives at a destination node, the destination node is instructed to release the resources it has dedicated to the call and modifies its slot vector accordingly 804. Next, the destination node transmits a destination node handshake back toward the source node via the relay nodes 806. The handshake is forwarded across the relay nodes back toward the source node 808. Note that the transmissions of the messages back and forth across the network is performed as discuss previously with regard to FIG. 7. After forwarding, the handshake is received at the source node 810, and the call is considered complete. This handshake provides assurances to the source node that the call has been successful.

Variable Bit-Rate Negotiation

In the communication scheme described herein, real-time variable bit-rate traffic may be thought of as a series of periodic bursts, with variable sized bursts. This is in contrast to the constant bit-rate, real-time traffic case, where all bursts are of the same size. The traffic profile of a variable bit-rate source may be characterized by two parameters, specifically the peak bit-rate and the average bit-rate. The QoS metric for this class of traffic is bounded by inter-node delay. Further, a probabilistic boundary exists based on the existing delay jitter. At call set-up, each new variable bit-rate connection is allocated a fixed bandwidth as in the case of a constant bit-rate connection on the route from the source to the destination. Along this route, the variable bit-rate call has priority access to the number of slots allocated to it. If the variable bit-rate burst in a particular frame generates fewer packets than the number of slots allocated to the call, the left over slots may be used for accommodating other traffic. In the alternative, datagrams may be piggybacked to variable bit-rate calls as well. If a variable bit-rate burst requires more slots than the number allocated to it, a negotiation process may be used, an example of which is be discussed below.

In this example, a node K, transmitting a burst piggybacks information that indicates:

(a) The number of slots required for the next burst that node K intends to transmit to the next relay node along the route to the destination, along with the node K's vector; and

(b) The number of slots in the next time division multiple access (TDMA) frame, which can be used for a subsequent burst from the previous node in the relay chain and in the positions of those slots.

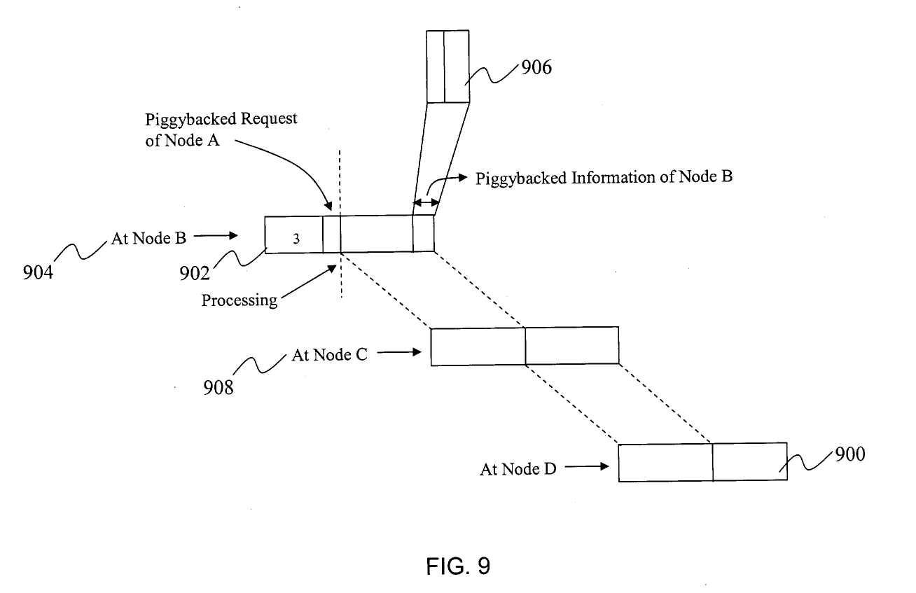

To illustrate the variable bit-rate negotiation process, an example is depicted in FIG. 9. It is assumed that a variable bit-rate connection is set up between a node A (not shown) and a node D 900. A fixed number of slots has been reserved for this connection as in the case of a constant bit-rate connection. As a non-limiting example for illustrating the process, the number of slots reserved for this connection is shown as three 902.

When node A transmits the current burst to node B 904, it piggybacks information that tells node B 904 the number of slots that are needed for node A to transmit its next burst. If the burst size is greater than three, then node A will also piggyback its vector to enable node B 904 to schedule the transmission of packets in excess of three. For example, if node A's next burst contains four packets, node B 904 will attempt to schedule the transmission of the one extra packet by examining its own vector and the vector of node A. When node B 904 transmits its burst, it includes the piggybacked control information 906, that gives node A the scheduling information needed for its next burst. In addition, node B 904 has to indicate to node C 908 the number of slots it requires for the next burst. Note that node A has to effectively listen to the transmission of node B 904 to node C 908 in order to extract the scheduling information.

The excess packets in a burst can only be accommodated on a link if there is available bandwidth on that link. Consequently, there may be a need to queue packets at one or more nodes before they may be transmitted. Packets may be time stamped and discarded if they cannot be accommodated within a reasonable time window. It is worth noting that since excess packets in a burst are scheduled in unreserved slots, there exists a possibility of packet losses due to collisions.

An admission control policy can be implemented to help handle drop offs of constant bit-rate calls and to ensure proper hand-offs in order to avoid loss of continuity. The admission control policy can reserve a number of TDMA slots for accommodating hand-off calls. If the total number of TDMA slots in a frame is M, and the number of slots reserved for hand-off calls is L, where L<M, then new calls will be blocked if the number of free slots at any of the nodes along the route is less than L. Hand-off calls, however, are allowed as long as the requisite number of free slots is available on alternate routes so that hand-off calls may be accommodated. Thus, a portion of bandwidth is reserved to ensure fault-tolerance. The portion of bandwidth may be adjusted to comport with desired system specifications. The admission controller limits the number of calls admitted to the system such that the probability of dropping handed-off calls is minimized. In addition, as explained previously, variable bit-rate calls are prone to packet losses. The admission controller must limit the number of calls admitted such that packet loss rates are tolerable.

What is claimed is:

1. A method for resource allocation in both TDMA and FDMA wireless ad-hoc network comprising the steps of:
a. providing a first call to a source node and determining if the source node was involved in an earlier call setup, if the source was previously involved in a different call setup, drop the first call;
b. utilizing a routing layer, query for a route to a destination node, if no route exists in the routing layer, determine if a route exists through one or more relay nodes, if a route is available, transmit a call setup packet which reserves a slot on each of the participating links between the source and destination nodes, and time-stamp a bandwidth request on each participating node;
c. rejecting subsequent requests for any of the reserved slots based on a request timestamp; and
d. maintaining the reservation on the links between source and destination nodes to guarantee a quality of service.

2. The method as set forth in claim 1, wherein said source node is waiting for one of the following:
a. an abort packet where the first call is dropped;
b. a timeout where the first call is dropped and a drop call packet is sent;
c. a relay setup message from the relay node indicating whether the first call is a success or a failure; and
if first call was a failure, drop the first call; if first call was successful, then allocate resources: on the source node, the relay nodes, and one or more of the destination nodes, and send a packet on assigned slot.

3. The method as set forth in claim 1, wherein a time-stamped relay node is queried if it is presently involved in a call setup for a second call;
if the time-stamped relay node is involved in the call setup for the second call, then check the timestamp of the second call;
if the timestamp of the second call is later than the stored timestamp of the first call then send the abort packet to the source node of the second call; and
if the timestamp of the second call is earlier than the stored timestamp of the first call then send the abort packet to the source node of the first call, and continue with call setup for the second call.

4. The method as set forth in claim 1, wherein a relay node is queried to determine if it is currently facilitating links between the source and destination nodes;
if the relay node is facilitating links between the source and destination nodes, reserve the required slot and forward packets to the destination node, and wait on the call setup;
if the relay node is not currently facilitating links between the source and destination nodes, wait on the call setup and upon call setup set the slot vector appropriately;
send the relay setup message to the source node and the destination node,
if the first call was a failure drop the first call;
if first call was successful allocate resources and send packet on assigned slot.

5. The method as set forth in claim 4, wherein the determination as to the success or failure of a call is determined by one of the following:
a. the source node;
b. the destination node.

6. The method as set forth in claim 1, wherein said destination node is queried to determine if it is involved in another call setup;
if destination node is involved in another call setup then check the timestamp;
if the timestamp of the second call is later than the stored timestamp of the first call then send the abort packet to the second call source node;
if the timestamp of the second call is earlier than the stored timestamp of the first call then send the abort packet to the first call source node;
if the destination node is not involved in another call setup or the destination node timestamp is earlier than stored timestamp then find an appropriate slot vector, collect relay-node information and send the call setup success or failure message;
set slot vector appropriately and send relay setup message to the source node and the destination node, the source node determines if the first call is a success or a failure;
if failure drop the first call; and
if successful allocate resource and send the packet on the assigned slot.

7. The method as set forth in claim 1, wherein a relay node is monitoring the transmissions of the next successive node along the route, if the relay node does not hear its successive relay node retransmit packets that it has been transmitting, said relay node recognizes that the route is no longer valid and sends a message to the source node indicating this transition, the source node then tries to reestablish the connection by first searching for a new route and then by reserving resources.

8. The method as set forth in claim 1, wherein said relay nodes are periodically transmitting control messages indicating their slot usage.

9. The method as set forth in claim 1, wherein said routing layer provides a route from the source node to the destination node, if no route is reported before a predetermined time-out then the call setup is aborted, if a route is reported the call setup message is transmitted in order to reserve resources.

10. The method as set forth in claim 1, wherein a variable bit-rate call is setup as a continuous bit-rate call allocating bandwidth approximately equal to the average variable bit-rate bandwidth requirement, and negotiating for additional slots as needed; in the event there are surplus slots they are relinquished to other variable bit-rate calls.

11. The method as set forth in claim 1, wherein said calls are variable bit-rate and may also carry data packets which are time-stamped and are discarded if they cannot be accommodated within a reasonable amount of time.

12. The method as set forth in claim 1, wherein at least one relay node reserves a portion of the available slots for a handoff call to minimize the possibility of dropping the handoff call.

13. A communications node comprising:
a. a means for determining if the node is already involved in a call set-up;
b. a means for determining if there is a route available to a destination node;
c. a means for transmitting a call set-up;
d. a means for dropping calls;
e. a means determining if a call set-up was a success or a failure; and
f. a means for allocating resources.

14. The communications node of claim 13, where the node communicates via wirelessly conveyed electromagnetic radiation.

15. A relay node comprising:
a. a means for determining if the node is involved in a call set-up;
b. a means for determining chronological order of all call set-up requests sent to the node;
c. a means for notifying an originating node of its status as a later arriving call set-up request;
d. a means for forwarding packets;
e. a means for allocating node resources; and
f. a means for maintaining resources until a predetermined event occurs.

16. The relay node of claim 15, where the node communicates via wirelessly conveyed electromagnetic radiation.

17. The relay node of claim 15, where the predetermined event is selected form the list comprising:
a. a timeout signal; and
b. a termination signal.

18. A destination node comprising:
a. a means for determining if the node is involved in a call set-up;
b. a means for determining chronological order of all call set-up requests sent to the node;
c. a means for notifying an originating node of its status as a later arriving call set-up request;
d. a means for allocating node resources; and
e. a means for maintaining resources until a predetermined event occurs.

19. The destination node of claim 18, where the node communicates via wirelessly conveyed electromagnetic radiation.

20. The destination node of claim 18, where the predetermined event is selected form the list comprising:
a. a timeout signal; and
b. a termination signal.

21. A method for communicating a call from a source node to a destination node in a wireless ad-hoc network, the method comprising steps of:
initializing a call by:
determining whether the source node is involved in an earlier call setup, and if the source node is involved in an earlier call setup, dropping the call; and
when the source node is not involved in an earlier call setup, pinging along a path from the source node to the destination node to determine whether the path can be used for call setup, and dropping the call when the path cannot be used for a call setup; and
when the path can be used for a call setup, transmitting a call setup packet along the path and awaiting a reaction relay setup message until a timeout is reached, and if the timeout is reached before the reaction relay setup message is received, transmitting a drop call packet and dropping the call; and
when a relay setup message is received before the timeout is reached, analyzing the relay setup message to determine whether the setup was a success, and if the setup was unsuccessful, transmitting a drop call packet and dropping the call; and
when the setup was successful, allocating resources to the call and transmitting call data.

22. A method for communicating a call from a source node to a destination node in a wireless ad-hoc network, as set forth in claim 21, wherein the method further comprises steps of:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

23. A method for communicating a call from a source node to a destination node in a wireless ad-hoc network, as set forth in claim 22, wherein the method further comprises steps of:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

24. A method for communicating a call from a source node to a destination node in a wireless ad-hoc network, as set forth in claim 23, wherein the method further comprises steps of:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.

25. A method for communicating a call from a source node to a destination node in a wireless ad-hoc network, the method comprising steps of:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

26. A method for communicating a call from a source node to a destination node in a wireless ad-hoc network, the method comprising steps of:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

27. A method for communicating a call from a source node to a destination node in a wireless ad-hoc network, the method comprising steps of:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.

28. A computer program product for communicating a call from a source node to a destination node in a wireless ad-hoc network, the computer program product comprising a computer readable medium comprising therein, means for:
initializing a call by:
determining whether the source node is involved in an earlier call setup, and if the source node is involved in an earlier call setup, dropping the call; and
when the source node is not involved in an earlier call setup, pinging along a path from the source node to the destination node to determine whether the path can be used for call setup, and dropping the call when the path cannot be used for a call setup; and
when the path can be used for a call setup, transmitting a call setup packet along the path and awaiting a reaction relay setup message until a timeout is reached, and if the timeout is reached before the reaction relay setup message is received, transmitting a drop call packet and dropping the call; and
when a relay setup message is received before the timeout is reached, analyzing the relay setup message to determine whether the setup was a success, and if the setup was unsuccessful, transmitting a drop call packet and dropping the call; and
when the setup was successful, allocating resources to the call and transmitting call data.

29. A computer program product for communicating a call from a source node to a destination node in a wireless ad-hoc network, as set forth in claim 28, further comprising means for:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

30. A computer program product for communicating a call from a source node to a destination node in a wireless ad-hoc network, as set forth in claim 29, further comprising means for:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

31. A computer program product for communicating a call from a source node to a destination node in a wireless ad-hoc network, as set forth in claim 30, further comprising means for:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.

32. A computer program product for communicating a call from a source node to a destination node in a wireless ad-hoc network, the computer program product comprising a computer readable medium comprising therein, means for:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

33. A computer program product for communicating a call from a source node to a destination node in a wireless ad-hoc network, the computer program product comprising a computer readable medium comprising therein, means for:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

34. A computer program product for communicating a call from a source node to a destination node in a wireless ad-hoc network, the computer program product comprising a computer readable medium comprising therein, means for:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.

35. A node for communicating a call from a source node to a destination node in a wireless ad-hoc network, the node comprising means for:
initializing a call by:
determining whether the source node is involved in an earlier call setup, and if the source node is involved in an earlier call setup, dropping the call; and
when the source node is not involved in an earlier call setup, pinging along a path from the source node to the destination node to determine whether the path can be used for call setup, and dropping the call when the path cannot be used for a call setup; and
when the path can be used for a call setup, transmitting a call setup packet along the path and awaiting a reaction relay setup message until a timeout is reached, and if the timeout is reached before the reaction relay setup message is received, transmitting a drop call packet and dropping the call; and
when a relay setup message is received before the timeout is reached, analyzing the relay setup message to determine whether the setup was a success, and if the setup was unsuccessful, transmitting a drop call packet and dropping the call; and
when the setup was successful, allocating resources to the call and transmitting call data.

36. A node for communicating a call from a source node to a destination node in a wireless ad-hoc network, as set forth in claim 35, the node further comprising means for:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

37. A node for communicating a call from a source node to a destination node in a wireless ad-hoc network, as set forth in claim 36, the node further comprising means for:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

38. A node for communicating a call from a source node to a destination node in a wireless ad-hoc network, as set forth in claim 37, the node further comprising means for:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.

39. A node for communicating a call from a source node to a destination node in a wireless ad-hoc network, the node comprising means for:
setting up a call between the source node and the destination node via relay nodes by:
receiving a call setup packet from a source node;
determining whether the relay or destination node is involved in an earlier call setup;
when the relay or destination node is already involved in an earlier call setup, determining whether a call involved in the earlier call setup has a higher priority than the call involved in the current call setup; and
if the current call setup has a higher priority, sending a negative relay setup message for all other calls so they are terminated; and
if the current call setup does not have a higher priority, sending a negative relay setup message to the source node, aborting the current call setup; and
when the relay or destination node is not already involved in an earlier call setup or when the relay or destination node is involved in an earlier call setup, but the current call setup has a higher priority, determining whether the relay or destination node is a relay node or a destination node;
if the relay or destination node is a destination node, finding an appropriate slot vector and sending a call setup response toward the source; and
if the relay or destination node is a relay node, forwarding a call setup packet toward a further destination node, finding an appropriate slot vector, awaiting and collecting relay node information from nodes toward the further destination node, and sending a call setup response toward the source; and
after the call setup response has been sent toward the source, determining whether the call setup was a success, and
when the call setup was not a success, sending a negative relay setup message to the source node, aborting the current call setup; and
when the call setup was a success, removing a call pendency and setting a slot vector, sending a relay setup message back toward a source node, and awaiting a data transaction.

40. A node for communicating a call from a source node to a destination node in a wireless ad-hoc network, the node comprising means for:
maintaining a call by:
waiting for a next packet; and
when the next packet is not received prior to the predetermined time period, releasing call resources and assuming the call terminated; and
when the next packet is received prior to a timeout, snooping for transmissions of a next node along the route to the destination node for a predetermined time period and determining whether the next node has further retransmitted a previous message;
when the next node has retransmitted the previous message within the predetermined time period, retransmitting the next packet to the next node and waiting for the next packet; and
when the next node has not retransmitted the previous message within the predetermined time period, transmitting a message back toward the source node to setup a new transmission path and releasing call resources.

41. A node for communicating a call from a source node to a destination node in a wireless ad-hoc network, the node comprising means for:
terminating a call by:
transmitting a call termination message from the source node toward the destination node via any relay nodes along the path from the source node to the destination node;
at each relay node along the path, receiving and retransmitting the call termination message, releasing call resources, and modifying a slot vector;
at the destination node, receiving the call termination message, releasing call resources, modifying a slot vector, and transmitting a destination handshake back along the path toward the source node;
at each relay node along the path, forwarding the destination handshake toward the source node; and
at the source node, receiving the handshake and releasing call resources.
